(19) United States
(12) Patent Application Publication
(10) Pub. No.: US 2019/0244396 A1
(43) Pub. Date: Aug. 8, 2019

(54) BUILDING MANAGEMENT SYSTEM WITH DYNAMIC COLOR MAP DATA

(71) Applicant: Carrier Corporation, Palm Beach Gardens, FL (US)

(72) Inventors: Doyle Davidson, Kennesaw, GA (US); Stephen C. Appling, Acworth, GA (US)

(21) Appl. No.: 16/271,584

(22) Filed: Feb. 8, 2019

Related U.S. Application Data
(60) Provisional application No. 62/628,086, filed on Feb. 8, 2018.

(51) Int. Cl. G06T 11/00

(52) U.S. Cl. CPC G06T 11/001; G06T 2200/24

(57) ABSTRACT

A system and method for using arbitrary tabular data for dynamic color map data visualizations. The system includes a controller, the controller configured to execute a process that includes identifying a desired graphical depiction having a color mapped to at least one graphical object on the graphical depiction and selecting a first data set associated with the graphical object. The method also includes ascertaining an attribute associated with the first data set and defining a color to be associated with at least one of the first data set and the attribute. The system also includes a display operably connected to the controller, the display configured to display the graphical depiction with the graphical elements having the at least one of the first data set and the attribute with the defined color.

### CROSS-REFERENCE TO RELATED APPLICATIONS

This application claims the benefit of 62/628,086 filed Feb. 8, 2018, which is incorporated herein by reference in its entirety.

### BACKGROUND

Exemplary embodiments pertain to the art of visualization of data, and more particularly to building management systems and environmental control systems visualizations in a graphical user interface.

A building management system can be used to monitor and/or control a building. For example, the user (e.g., operator) of a building management system can check and/or set the state of a control component(s), equipment, device(s), network (s) area(s), and/or space(s) of the building using the building management system. For instance, if an occupant is too hot or too cold, a building manager can investigate with the building management system to determine the temperature in the particular building space, any exceedances from set points, malfunctioning equipment and the like. As another example, a building management system of a building may perform multiple tasks or functions including that related to security, safety, environmental conditioning, and others. Environmental conditioning systems such as heating, ventilation, and air conditioning (HVAC) systems maintain desirable function and standards of service by keeping the environment in a building within a defined comfort zone of occupants. While it is desirable to maintain such high standards, the environmental conditioning systems utilize considerable energy at a substantial cost. To reduce environmental conditioning costs, computer-based controllers of the building management system, or dedicated controllers of the environmental conditioning systems may be preprogrammed to generally start up and shut down at prescribed times based on scheduled occupancy (e.g., working hours in a building that conducts business), usage or other factors associated with the building.

A building management system may display a graphical user interface to the operator. The user interface with multiple views can include, for example, the floor plan of the building, or buildings with additional information about the building(s), (e.g., information about one or more device(s) of the building, information about a control network(s) of the building, schematic graphics of the building, etc.) overlaid on the floor plan. The user interface may also include a number of tools or functions that the operator can use to set and/or update the building information. Further, the floor plan of the building may be illustrated with additional information regarding the condition or status of a building space, the building or a campus. Furthermore, information about the building may be identified by various illustrations or color coded to display information about a building or an attribute or characteristic of a system in a building. For example in an embodiment in a building management system each environmentally controlled space might employ a different color to depict the status of the space. For example, green for occupied, gray for unoccupied. In another example, color coding may be employed to identify current or past performance relative to given set of points in the building. For example, green if the space is at the set point, red if the temperature in the space has exceeded the set point, and blue if the space is currently below the set point.

In previous building management systems, some or all of the components of the user interface may be limited or need be manually generated. For example, the control engineer may have to manually program the desired colors to generate the graphics of the building. Moreover, flexibility in modifications may be limited and thereby provides limited variations of information. Limited displays and flexibility limit the information that can be conveyed via the user interface of the building management system.

### BRIEF DESCRIPTION

Described herein in an embodiment is a system and method for using arbitrary tabular data for dynamic color map data visualizations. The system includes a controller, the controller configured to execute a process that includes identifying a desired graphical depiction having a color mapped to at least one graphical object on the graphical depiction and selecting a first data set associated with the graphical object. The method also includes ascertaining an attribute associated with the first data set and defining a color to be associated with at least one of the first data set and the attribute. The system also includes a display operably connected to the controller, the display configured to display the graphical depiction with the graphical elements having the at least one of the first data set and the attribute with the defined color.

In addition to one or more of the features described above, or as an alternative, further embodiments may include that the selecting includes identifying data associated with the graphical object that a user desires to associate with a visualization.

In addition to one or more of the features described above, or as an alternative, further embodiments may include that the ascertaining includes establishing an expression for the first data set.

In addition to one or more of the features described above, or as an alternative, further embodiments may include that the expression is a mathematical relationship associated with the first data set.

In addition to one or more of the features described above, or as an alternative, further embodiments may include that the graphical depiction is a map or layout associated with a building management system.

In addition to one or more of the features described above, or as an alternative, further embodiments may include that the map is at least one of a campus having a plurality of buildings and a building having a plurality of building spaces and the graphical elements are the buildings or building spaces.

In addition to one or more of the features described above, or as an alternative, further embodiments may include that the building management system, an environmental control system, an elevator system, and an access control and security system.

In addition to one or more of the features described above, or as an alternative, further embodiments may include that the selected parameter includes at least one of environmental, mechanical, occupancy, and access control or security data.

In addition to one or more of the features described above, or as an alternative, further embodiments may include that the selected parameter includes at least one of temperature, temperature set point, and occupancy.

In addition to one or more of the features described above, or as an alternative, further embodiments may include that the attribute for the selected parameter includes a deviation of the temperature from the temperature set point.

In addition to one or more of the features described above, or as an alternative, further embodiments may include generating a report in a building management system including at least a first result of the selecting, ascertaining, and establishing.

In addition to one or more of the features described above, or as an alternative, further embodiments may include that the report includes a table of the at least a first result.

In addition to one or more of the features described above, or as an alternative, further embodiments may include: applying a result of the selecting, ascertaining, and establishing to another graphical depiction having another graphical element; and displaying the another graphical depiction with the another graphical elements employing the defined color.

Also described herein in an exemplary embodiment is a system for using arbitrary tabular data for dynamic color map data visualizations. The system includes a controller, the controller configured to execute a process including identifying a desired graphical depiction having a color mapped to at least one graphical object on the graphical depiction, selecting a first data set associated with the graphical object, ascertaining an attribute associated with the first data set, and establishing a rule defining a color to be associated with at least one of the first data set and the attribute. The system also includes a display, the display operably connected to the controller, the display configured to display the graphical depiction with the graphical elements having the at least one of the first data set and the attribute with the defined color.

In addition to one or more of the features described above, or as an alternative, further embodiments may include that the selecting includes identifying data associated with the graphical object that a user desires to associate with a visualization.

In addition to one or more of the features described above, or as an alternative, further embodiments may include that the ascertaining includes establishing an expression for the first data set.

In addition to one or more of the features described above, or as an alternative, further embodiments may include that the controller is configured to generate a report in a building management system including at least a first result of the selecting, ascertaining, and defining.

In addition to one or more of the features described above, or as an alternative, further embodiments may include that the controller is configured to apply a result of the selecting, ascertaining, and establishing to another graphical depiction having another graphical element; and the display configured to display the another graphical depiction with the another graphical elements employing the defined color.

Also described herein in an embodiment is a building management system for controlling and monitoring systems in a building including an environmental control system. The building management system including environmental conditioning hardware constructed and arranged to condition the environment of the building; and a controller including an environment module configured to receive data associated with the environmental control system. The controller is configured to execute a process including identifying a desired graphical depiction having a color mapped to at least one graphical object on the graphical depiction, selecting a first data set associated with the graphical object, ascertaining an attribute associated with the first data set, and establishing a rule defining a color to be associated with at least one of the first data set and the attribute. The building management system also includes a display, the display operably connected to the controller, the display configured to display the graphical depiction with the graphical elements having the at least one of the first data set and the attribute with the defined color.

### BRIEF DESCRIPTION OF THE DRAWINGS

The foregoing and other features, and advantages of the present disclosure are apparent from the following detailed description taken in conjunction with the accompanying drawings in which:

FIG. 1 is a schematic of a building management system including an environmental conditioning system as one exemplary embodiment;

FIG. 2 is a depiction of a cloud computing environment as may be employed with the building management system in accordance with an embodiment;

FIG. 3 depicts a simplified block diagram of a computing system as may be implemented in a controller or user device in accordance with an embodiment;

FIG. 4 depicts a simplified graphical depiction of a campus of buildings and tools of the building management system in accordance with an embodiment;

FIG. 5A depicts a simplified screen shot of a graphical user interface of a building management system in accordance with an embodiment;

FIG. 5B depicts a simplified screen shot of a graphical user interface of a building management system in accordance with an embodiment;

FIG. 5C depicts a simplified screen shot of a graphical user interface of a building management system in accordance with an embodiment;

FIG. 5D depicts a simplified screen shot of a graphical user interface of a building management system in accordance with an embodiment;

FIG. 5E depicts a simplified screen shot of a graphical user interface of a building management system in accordance with an embodiment;

FIG. 5F depicts a simplified graphical depiction of a campus of buildings with the color mapping in accordance with an embodiment;

FIG. 5G depicts a simplified graphical depiction of the campus of buildings of FIG. 5F with the color mapping based on different data in accordance with an embodiment; and

FIG. 6 is a flowchart of a method of using tabular data as a basis for dynamic color map data visualizations in accordance with an embodiment.

### DETAILED DESCRIPTION

Embodiments herein are directed to a building management system and a graphical user interface that facilitates a user, building owner, tenant or operator the capability to construct a report employing mapping of an arbitrary set of data to a set of colors using specified set of rules and or functions. The report can then be assigned to one or more graphics or graphical depictions from the building management system that each contain a preselected set of location associations. The graphic associations for each graphic can then display any set of colors defined in the report with no additional configuration by the user. The user can dynamically select the data set to display. For example existing building management systems employ color maps (graphical maps of customer buildings/campus) to depict “thermographic data” associated with the building, campus, and the like. In one example, the depiction represents temperature set point compliance for the building space. That is, for a given building, building space, room, zone, and the like a color indicates the status of the compliance, e.g., red, exceeded set point, blue for below set point, or green for on set point. Such a color map and its history provides useful insight to owners, operators, and the like regarding the operation of the environmental conditioning system.

The described embodiments provide better insight into building data. By leveraging existing color map graphics, and in addition providing alternate color definitions based on other user defined data, more dynamic and custom visualizations can be achieved in a simple and reusable fashion. In operation, this is accomplished using a tabular data definition combined with enhancing the existing “color map” graphical user interface controls (widget) used in the building management system graphic pages. Examples of calculated color values that may be shown include, but are not limited to total energy usage, normalized energy usage, alarm counts, financial performance, and the like.

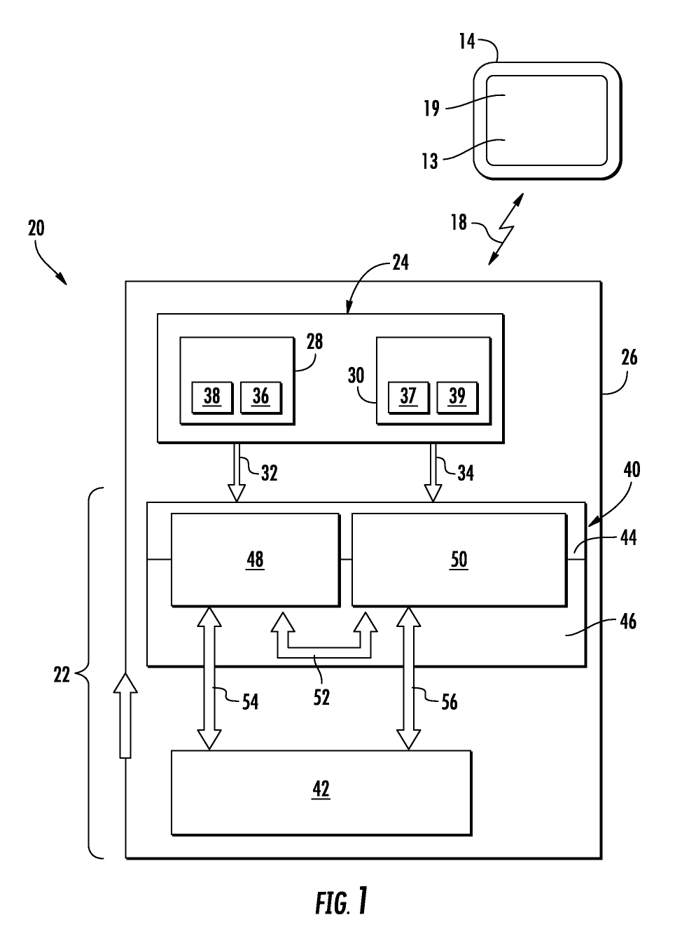

Referring to FIG. 1, a building management system 20 may be constructed and arranged to handle a host of building functions and/or attributes including that related to environmental conditioning, security, safety, fire protection, occupancy detection or monitoring, various combination thereof, and other functions. Environmental conditioning may be handled, at least in-part, by an environmental conditioning system 22 that may expend energy to control factors such as heating, cooling, humidity, lighting and other factors. Other aspects of the building management system 20 may include an occupancy and environment monitoring system 24 that may be configured to at least monitor the number of occupants (e.g., people, livestock, pets, etc.) entering and/or leaving a building or region 26. The occupancy and environment monitoring system 24 may be part of any variety of subsystems of the building management system 20 including, for example, part of an access control security system. Alternatively, the occupancy and environment monitoring system 24 may be a dedicated part of the environmental conditioning system 22. It is further contemplated and understood that the region 26 may be an entire building, a floor of the building, and/or specific areas of the building or floor. Moreover, a building management system 20 could also provide services for and manage multiple buildings 26, for example a campus.

The occupancy and environment monitoring system 24 may include an event module 28 for monitoring and tracking ingress and egress activity in the building space 26. The ingress and egress event module 28 is configured to respectively send ingress and egress data (as depicted by arrow 32) to the environmental conditioning system 22, and in particular controller 40. Together, the ingress and egress data 32 may be termed ‘occupancy data’ The ingress and egress modules may include respective ingress and egress sensing devices 36, 38. In one embodiment, one or both of the sensing devices 36, 38 may be, for example, security card or badge readers configured to read and identify security cards (or badges) worn by occupants entering and exiting the building 26. In another embodiment, the sensing device 36 and/or the sensing device 38 may be an electrical contact mounted to a door, and configured to send a door actuation signal indicative of one or more occupants leaving the building 26. It is further contemplated and understood that the sensing devices 36, 38 may be associated with any technology that applies an ‘access granted’ method including biometric scanners and mobile device commands.

The environment monitoring system 24 may also include a sensing module 30 for monitoring and tracking environmental settings and conditions associated with the building space 26. The environment sensing module 30 is configured to send environmental data (as depicted by arrow 34) to the environmental conditioning system 22, and in particular controller 40. Together, the environment sensor and status data 34 may be termed ‘environment data.’ The sensing modules may include respective environment sensing and operational devices 37, 39. In one embodiment, one or both of the sensing devices 37, 39 may be, for example, thermostats, controllers, temperatures sensors, humidity sensors, or C02 sensors throughout the building 26. In another embodiment, the sensing devices 37 and/or the sensing device 39 may also include a mobile device for interfacing with the environment control system 22. It is further contemplated and understood that the sensing devices 37, 39 may be associated with any technology that applies an environment sensing and/or control method including biometric scanners and mobile device commands.

The modules 28, 30 may further include a controller, or a common controller (not shown), as part of the environment monitoring system 24 that may be, or may be part of, a security system or environmental control system e.g. 22. The controller(s) may be configured to receive the signals outputted by the sensing devices 36, 38, 37, 39, among others, process the signals, and output the occupancy data 32, and/or environmental data 34 to the environmental conditioning system 22. In another embodiment, the controller(s) may process the signals from sensors such as the sensing devices 36, 38, 37, 39 and output a signal indicative of combined occupancy data 32 and environmental data 34.

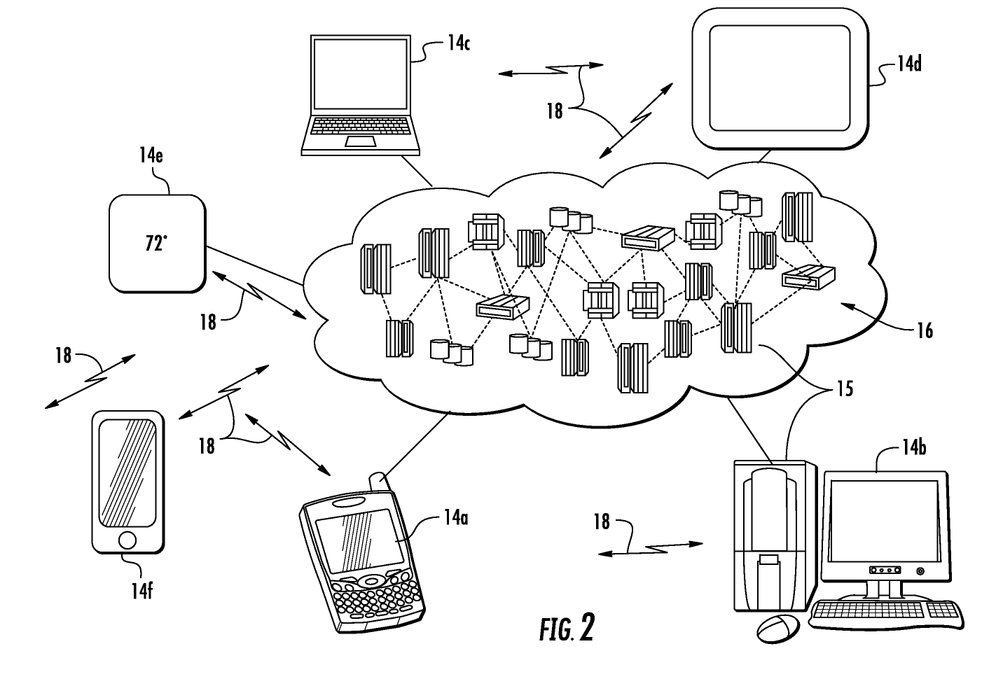

Turning now to FIG. 2 as well, the environmental conditioning system 22 may include one or more controller(s) 40 and environmental conditioning hardware 42 that may generally be started, monitored, stopped, and otherwise controlled by the controller 40. The environmental conditioning hardware 42 may include hardware components, known to one having skill in the art, for the heating, cooling, control of humidity, lighting, and/or control of other factors pertaining to the environment. The controller 40 may be an integral part of a controller of the building management system 20, or may be a dedicated controller of the environmental conditioning system 22 or other systems like a security system or access control system, and the like. The controller 40 may also be part of a server denoted generally as 15 (FIG. 2) that is employed to interface with other components of the building management system 20 and execute processes for building management, environmental control, and visualization of dynamic data in accordance with the embodiments described herein. In addition, some, or all of the functionality provided may be based on methods and processes executed locally or remotely such as on a local or remote server 15 and/or cloud computing environment 16. As will be appreciated the cloud computing environment 16 could include a local or remote server 15, or the server 16 and cloud computing environment 16 could be entirely remote. As used herein, the processing of the embodiments described herein may be executed in the controller 40 or server 15 or other servers all to be referred to herein generally as controller 40. The controller 40 may include a processor 44 (e.g., microprocessor), a computer writeable and readable storage medium 46, memory, displays and the like as described in further detail herein. The controller 40 may be configured to receive the occupancy data 32 and environmental data 34 from the environment monitoring system 24. The controller 40 may also be configured to receive data from various other sensors associated with the environmental conditioning system 22 and the building management system 20. For example, building state, time, date, operational information and commands, and the like. Likewise, the controller 40 may be configured to receive data from the various components of the environmental conditions hardware 42, including but not limited to states of fans, pumps, valves, dampers and the like all depicted generally as 54, 56.

The building management system 20 may further include a user device 14 that is employed to facilitate interfaces with the system 20 as will be described at a later point herein. The user device 14 is configured to interface with the controller 40 in order to facilitate operation of and interfaces with the building management system. In some embodiments, the user device 14 may incorporate some or all of the functions of the controller 40.

The building management system 20 may also include a local and remote communication network and system, shown generally as 18 for facilitating communication and control of various features in the system 20 as well as for facilitating communication between a user device 14, controller 40, server 15, and the cloud computing environment 16, other components and sensors in the system and the like. Likewise, the system 20 may also include one or more application(s) (app) 19 operable on the user device 14, that permits and facilitates the user to enter and receive information and for user device 14 to communicate with, interface with, and control selected aspects of system 20. The app 19 and the user device 14 may include a user interface 13 to enable the user 12 to interface with the user device 14 and the app 19 being executed thereon. In an embodiment, the app 19 may be employed by the user 12, for example to facilitate use of tabular data for dynamic color map data visualizations associated with the building system 20. The app 19 may also facilitate establishing user preferences associated with the system 10 and methods described herein.

Controller 40 may include one or more functions, modules, or applications 48, 50 for controlling various aspects of the building management system 20. More specifically, the modules 48, 50 may, at least in-part, be software-based or computer programs including a variety of user defined settings, preferences, thresholds and may further include a variety of operational commands that may be stored in the storage medium 46 and executed by the processor 44 of the controller 40. In one embodiment, the modules 48, 50 may be programmed to receive the respective occupancy data 32, or environmental data 34 associated with the building 26. In an embodiment, the data 32, 34 may be received at intervals or continuously (i.e., 24 hours a day, 7 days a week).

The modules 48, 50 and thus the controller 40 may generally communicate with one-another (see arrow 52 in FIG. 1) to generally share data, information, status and the like. In addition, the modules 48, 50 and thus the controller 40 also communicates with the environmental control hardware 42 as depicted by arrows 54, 56 respectively.

Server 15 may be part of a cloud computing environment 16. Cloud computing is a widely adopted and evolving concept. Generally, cloud computing refers to a model for enabling ubiquitous, convenient, and on-demand access via Internet to shared pools of configurable computing resources such as networks, servers, storages, applications, functionalities, and the like. There are a number of benefits associated with cloud computing for both the providers of the computing resources and their customers. For example, customers may develop and deploy various business applications on a cloud infrastructure supplied by a cloud provider without the cost and complexity to procure and manage the hardware and software necessary to execute the applications. The customers do not need to manage or control the underlying cloud infrastructure, e.g., including network, servers, operating systems, storage, etc., but still have control over the deployed applications. On the other hand, the provider's computing resources are available to provide multiple customers with different physical and virtual resources dynamically assigned and reassigned according to clients' load. Further, cloud resources and applications are accessible via the Internet.

Continuing now with FIG. 2, an illustrative cloud computing environment 16 as may be interfaces with the building management system 20 is depicted. As shown, cloud computing environment 16 includes one or more cloud computing nodes, such as processing or communication nodes e.g, servers 15 with which user devices, computing devices and controllers all denoted in various configurations as 14a-f may communicate. Cloud computing nodes 15 may communicate with one another and/or be grouped (not shown) physically or virtually, in one or more networks, such as Private, Community, Public, or Hybrid clouds, or in one or more combinations thereof. This allows cloud computing environment to offer infrastructure, platforms and/or software as services for which a cloud consumer does not need to maintain or minimize resources at a local computing device level. It is understood that the types of user/computing devices 14 shown in FIG. 2 are intended to be illustrative only and that computing nodes and cloud computing environment 16 can communicate with any type of computerized device over any type of network and/or network addressable connection (e.g., using a web browser).

The computing devices 14a-f such as user device 14 may be any form of a mobile device (e.g., smart phone, smart watch, wearable technology, laptop, tablet, etc.). The user device 14 can include several types of devices, in one instance, even a fixed device, e.g. a keypad/touch screen affixed to a wall in a building corridor/lobby, such as building system controllers. In other words, the server 15 and the user device 14 can all be computing devices 14a-f. It should be appreciated that the servers 15 are typically part of the installed building system infrastructure, while commonly, the user device 14, particularly mobile devices such as 14a, 14d, and 14f may typically be owned and used by the user 12, service man, homeowner, and the like. The term “user device” 14 is used to denote all of these types of devices as may be employed by the user 12 for the purposes of communication with the building system 20. It should be appreciated that in some instances a user device 14 or the server 15 are proximate to the system(s) 20, for example, a particular locale, in others they are mobile for example, a car, PDA, or movable kiosk. For example, in an embodiment, the computing devices 14 could be, a personal digital assistant (PDA) or cellular telephone tablet 14a, such as user device 14, desktop computer/terminal/server 14b, laptop computer 14c, a tablet or kiosk 14d, or a control panel of some sort for a building system 14e, mobile phone, 14f, and the like. Computing devices 14a-f may also be configured to communicate with each other or a variety of sensors e.g., 26, 37, 38, 39 directly or via communication network 18.

The computing devices, 14a-f such as user device 14, as well as other components of the system 20 can communicate with one another, in accordance with the embodiments of the present disclosure, e.g., as shown in FIG. 1. For example, one or more user devices 14 or a server 15 may communicate with one another when proximate to one another (e.g., within a threshold distance). The user device 14 and server 15 may communicate over one or more communication networks 18, (e.g., a communication bus) that may be wired or wireless. Wireless communication networks can include, but are not limited to, Wi-Fi, short-range radio (e.g., Bluetooth( ), near-field (NFC), infrared, cellular network, etc. In some embodiments, user device 14 (e.g., computing device 14a-14f may include, or be associated with (e.g., communicatively coupled to) one or more other networked building elements (not shown), such as computers, beacons, other system controllers, bridges, routers, network nodes, etc. The networked elements may also communicate directly or indirectly with the user devices 14 using one or more communication protocols or standards (e.g., through the network 18). For example, the networked element may communicate with the user device 14 using near-field communications (NFC) and thus enable communication between the user device and any other components in the system 20 when in close proximity to the user device 14 (NFC is a short range wireless protocol). Or, for example, the networked element may communicate with the user device 14 using Bluetooth and thus communicate a unique ID and enable communication between the user device 14 and building system control unit 40 or any other components in the system 20 from a further distance. The network 18 may be any type of known communication network including, but not limited to, a wide area network (WAN), a local area network (LAN), a global network (e.g. Internet), a virtual private network (VPN), a cloud network, and an intranet. The network 18 may be implemented using a wireless network or any kind of physical network implementation known in the art. The user devices 14 and/or the computing devices may be coupled to the server 15, through multiple networks (e.g., cellular and Internet) so that not all user devices 14 and/or the computing devices are coupled to the any given server 15 or component through the same network 18. One or more of the user devices 14 and servers 15 may be connected in a wireless fashion. In one non-limiting embodiment, the network 18 is the Internet and one or more of the user devices 14 executes a user interface application (e.g. a web browser, mobile app 19) to contact and communicate through the network 18.

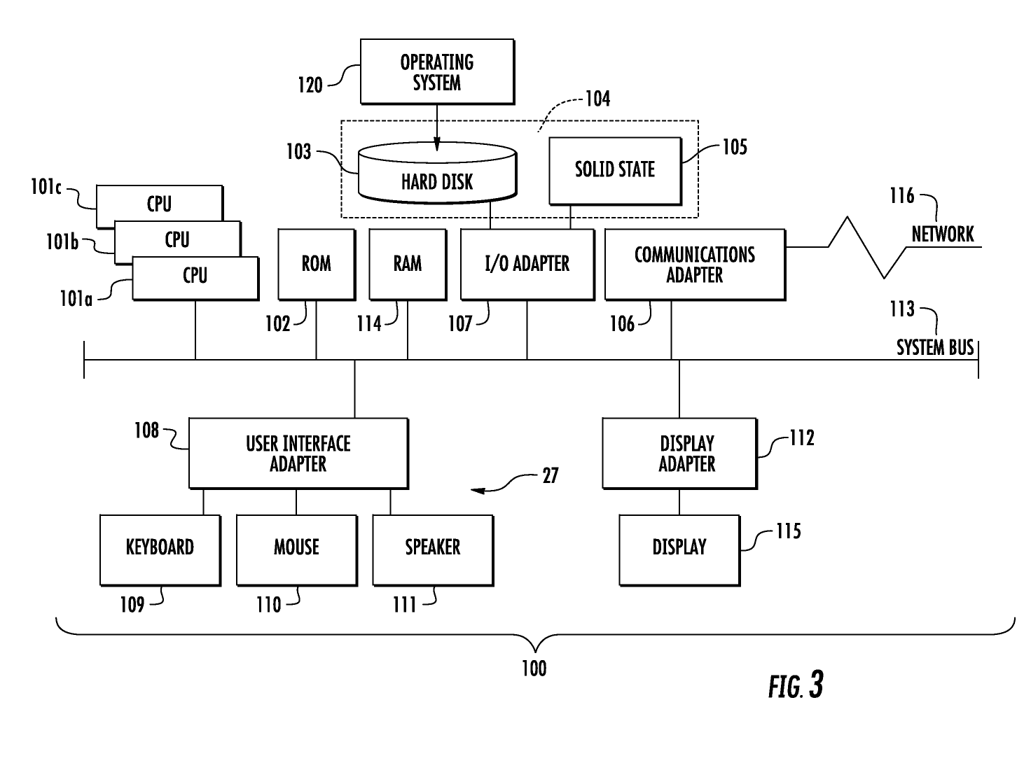

Referring to FIG. 3, the computing devices 14a-f, may include a processing/computing system 100 including a processor, memory, and communication module(s), as needed to perform the functions of recognition and authentication based on dynamic data in accordance with an embodiment. In one embodiment, the computing devices 14a-f, and servers 15, controller 40 each may include a computing system 100 having a computer program stored on nonvolatile memory to execute instructions via a microprocessor related to aspects of building management and control and the data visualization of the embodiments described herein.

In an embodiment, the computing system 100 has one or more processing units (processors) 101a, 101b, 101c, etc. (collectively or generically referred to as processor(s) 101). The processor 101 can be any type or combination of computer processors, such as a microprocessor, microcontroller, digital signal processor, application specific integrated circuit, programmable logic device, and/or field programmable gate array. As is conventionally done, the processors 101 are coupled to system memory 114 and various other components via a system bus 113. The memory can be a non-transitory computer readable storage medium tangibly embodied in the user including executable instructions stored therein, for instance, as firmware. Read only memory (ROM) 102 is coupled to the system bus 113 and may include a basic operating system, which controls certain basic functions of system 100. Random Access Memory (RAM) 114 is also coupled to the system bus 113 and may include a basic storage space to facilitate program execution.

FIG. 3 further depicts an input/output (I/O) adapter 107 and a network adapter 106 coupled to the system bus 113. I/O adapter 107 communicates with hard disk 103 and/or solid state storage 105 or any other similar component. I/O adapter 107, hard disk 103, and solid state storage 105 are collectively referred to herein as mass storage 104. As is conventionally done an operating system 120 for execution on the processing system 100 may be stored in mass storage 104. A network adapter 106 interconnects bus 113 with an outside network 116 such as and including communications network 28 and the like, enabling computing system 100 to communicate with other such systems. The network adapter 106 may implement one or more communication protocols as described in further detail herein, and may include features to enable wired or wireless communication with external and/or remote devices separate from the user device 14. The computing device 14a-e including the user device 14 and controller 40 may further include a user interface, shown generally as 13, e.g., a display screen, a microphone, speakers, input elements such as a keyboard 109 or touch screen, etc. as shown in FIG. 3) as known in the art. A screen (e.g., a display monitor) 115 is connected to system bus 113 by display adaptor 112, which may include a graphics adapter and a video controller. A keyboard 109, mouse 110, and speaker 111 all interconnected to bus 113 via user interface adapter 108. It should be appreciated that in some embodiments some or all of these elements of the computing system 100 may be integrated. In one embodiment, adapters 107, 106, and 112 may be connected to one or more I/O busses that are connected to system bus 113 via an intermediate bus bridge (not shown). Suitable I/O buses for connecting peripheral devices may also be employed. Additional input/output devices are shown as connected to system bus 113 via user interface adapter 108 and display adapter 112. It should be appreciated that the components of the system as described are for illustration purposes only. Features and functions as described may be omitted, integrated, or distributed as desired and as required to suit a particular application.

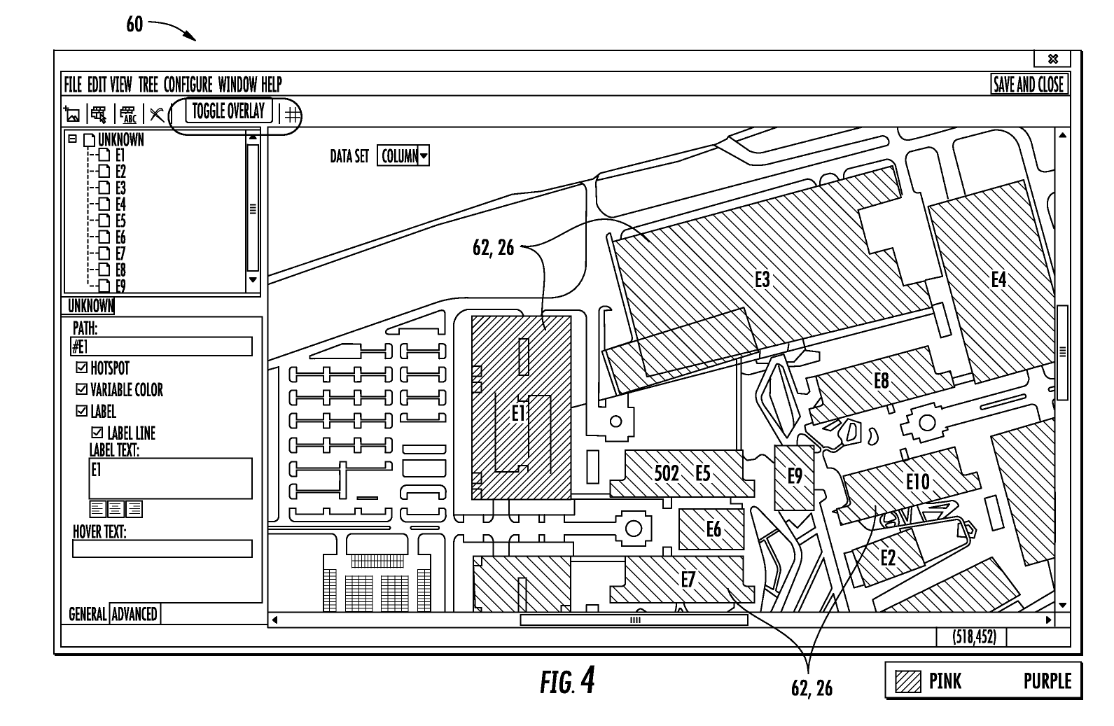

Turning now to FIG. 4 depicting a simplified screen shot and graphical depiction 60 associated with a place of interest in accordance with an embodiment. For example, in an embodiment the graphical depiction 60 is a campus of buildings 26, a building layout, or floorplan (not shown). In another embodiment, the graphical depiction 60 could be associated with parts of a mechanical system, or an access control system. For example, the described embodiments are readily applicable to a data center implementation where the graphical depiction 60 might be an image of component temperatures of rack mounted computers being monitored. It could also be used for parts of mechanical equipment, for example to indicate the speed of fans in a cooling tower and the like. As described herein, the embodiments are described with reference to an arrangement of buildings 26 that depicts a campus with a plurality of buildings 26 or a building 26 depicted as a plurality graphical objects 62 associated with the graphical depiction 60 associated with a place of interest. For example a campus of buildings 26, or a building 26 having a plurality of building spaces e.g., rooms (not shown). In an embodiment, one or more arbitrary sets of data values is mapped to any color using rules and/or functions as may be desired. When the rules and mapping are applied to the graphical depiction, the graphical objects, e.g., buildings, being displayed with the selected color mapping based on the data and the applied rules. It should be appreciated that this description and depiction is merely illustrative and the described embodiments are equally applicable to any system or configuration where color mapping is employed to depict data, a characteristic, or attribute associated with an item whether it is a building 26, building space or equipment or other application.

In FIG. 4 a graphical depiction 60 of a campus of buildings 26 as graphical objects 62 is depicted with a “birdseye view.” The graphical objects 62, e.g., buildings 26 (or a building space) may initially be given a color coding based on a given selected condition or variable associated with each of the buildings 26 or building space, e.g., temperature, occupancy, and the like. It is noteworthy to appreciate that most of the graphical objects 62, e.g., buildings 26 are depicted with the same color typically preset and based on a limited number of predefined variables and conditions with little or no flexibility to display other information. When drawing the raw graphic, the chosen color is irrelevant and will be replaced with the computed color as defined by the described embodiments.

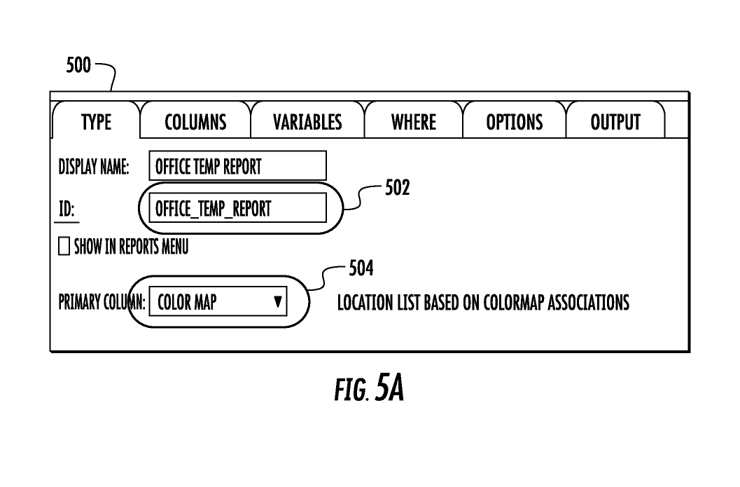

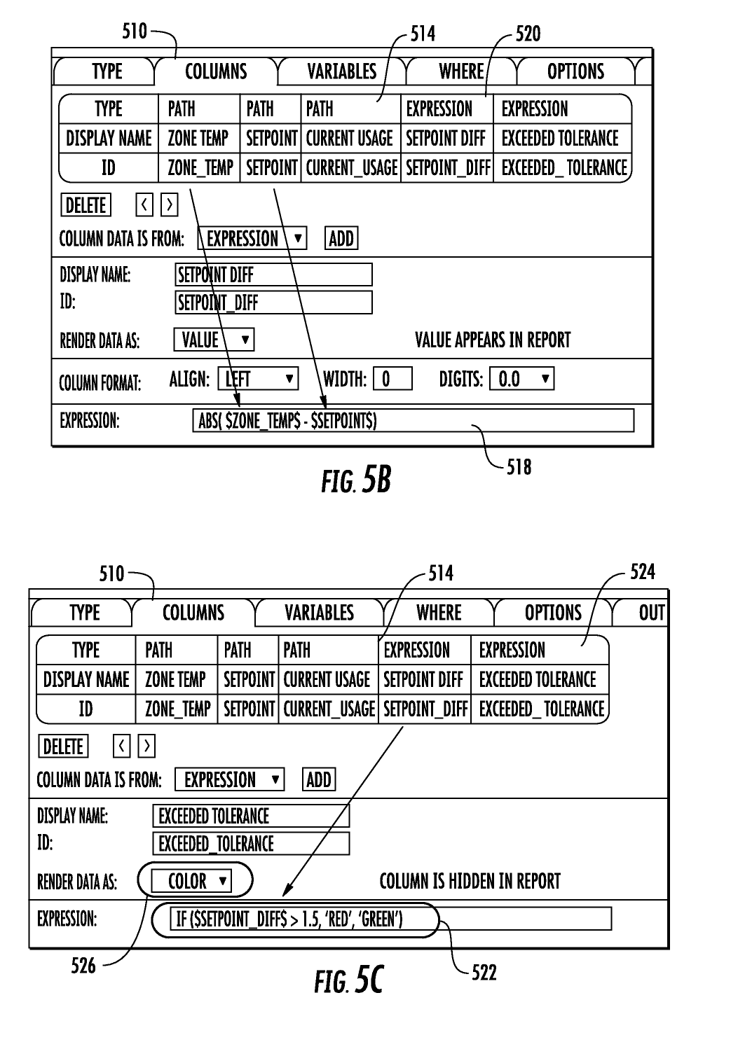

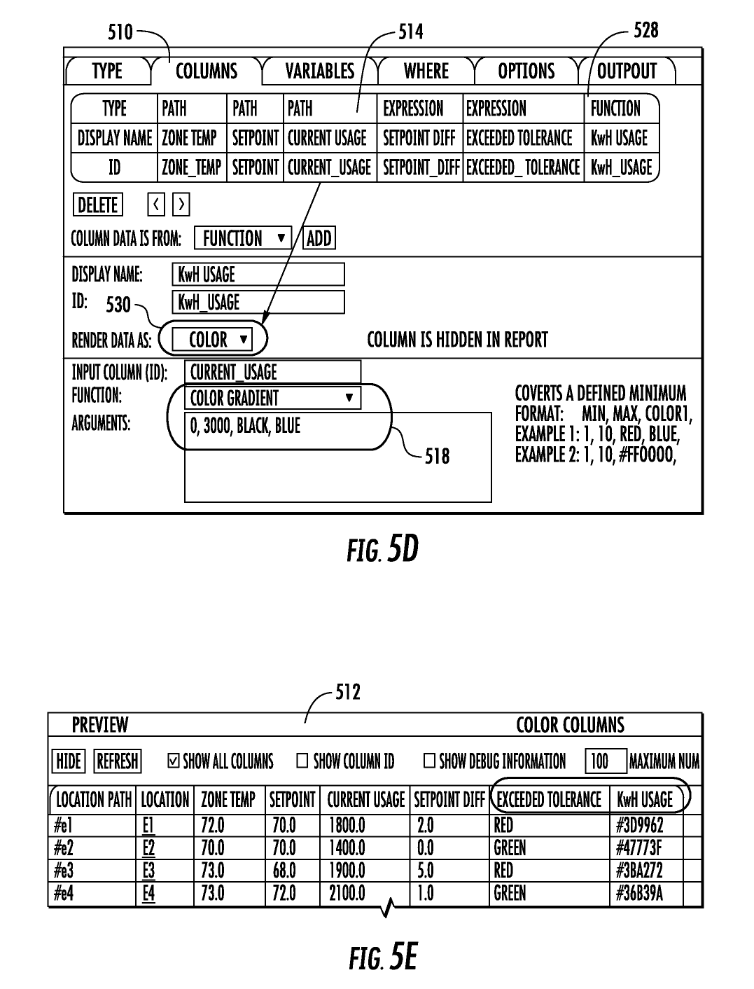

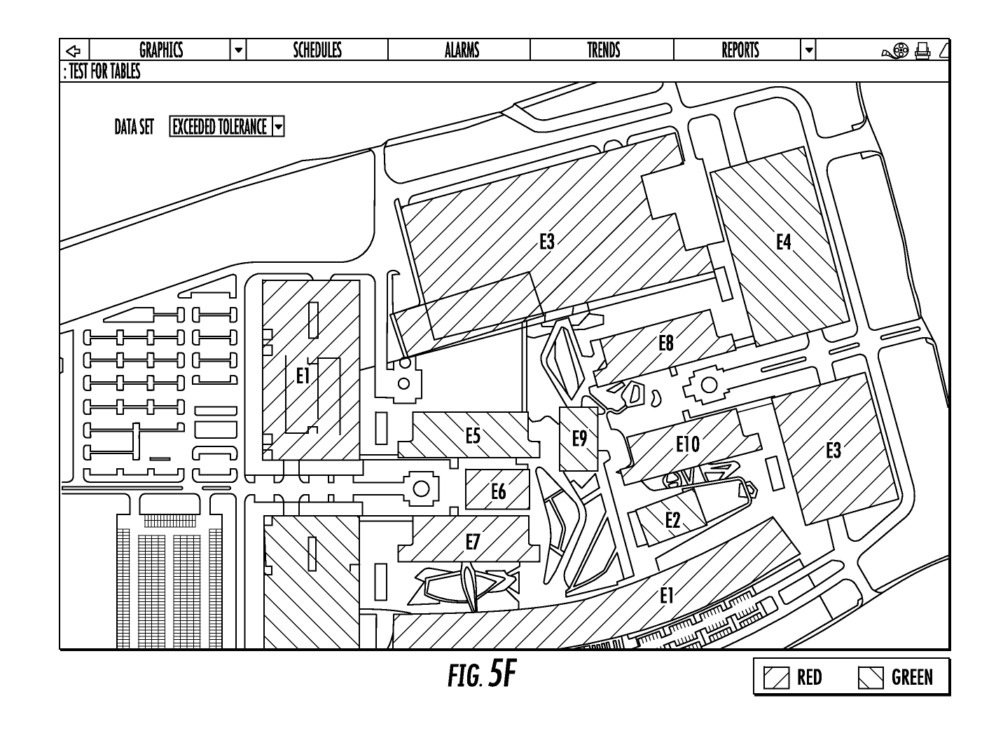

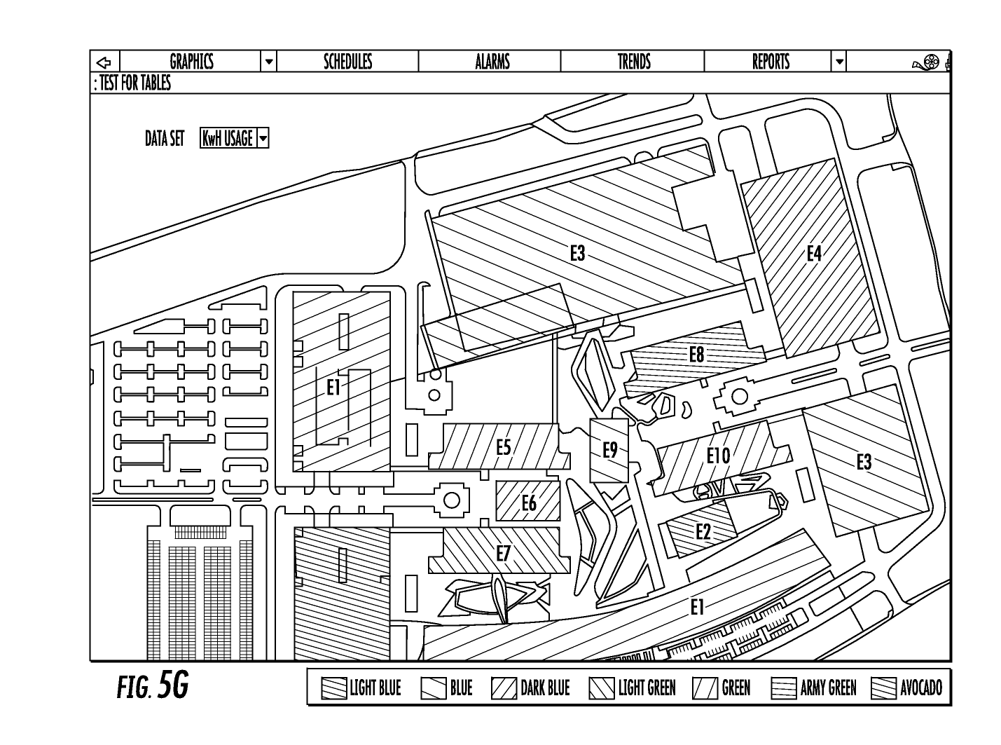

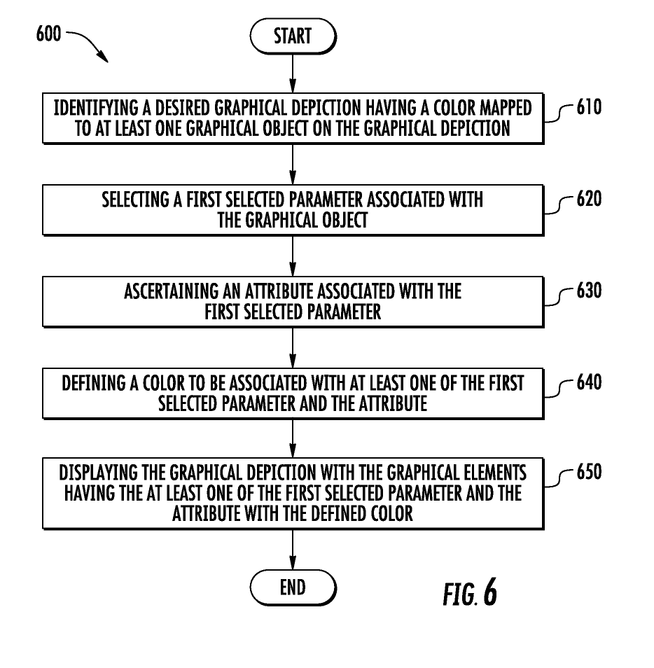

Turning now to FIG. 5A as well, to facilitate improved dynamic color mapping visualizations of the described embodiments, an arbitrary data table is generated which is then associated with the existing graphical depiction 60. For example, in an embodiment, a user employing a graphical user interface associated with a building management system 20 selects a custom report or table to be used with the graphic. Once again, it will be appreciated that the graphical user interface could be operating on any form of user device 14, whether a mobile device, tablet, laptop, kiosk, or a standalone work station, and the like. In an embodiment, when the report is associated with the existing graphic, the colors used are then redefined based on “color columns” defined in the report. More specifically, in an embodiment, a new report is created by the user employing a graphical user interface operating on one or more of the user devices 14 of the building management system 20. FIG. 5A depicts setting up the report termed “office_temp_report” 502 using the “Type” tab 500 and establishing a color map as the primary column as shown at 504. In operation, this defines the information upon which the color mapping will be based is to be from the graphical objects 62 in the graphical depiction 60 (as shown in FIG. 4.

Turning to FIG. 5B, the user selects the “Columns” tab 510. In an embodiment once the user defines the report's primary column to be based on a desired color scheme a data table 512 is established depicting the various columns of the report as the user selects or adds them. That is, in an embodiment, a user selects/defines what the rows in the report are to be (i.e., in this instance, a variety of colors) as depicted by 514. The rows of the report are based on data set or parameters associated with the graphical objects 62 e.g., buildings 26 and the like, in the graphical depiction 60. It should be appreciated that the definitions could be based on other things besides being associated with the graphical objects 62. For example, the rows could be based on a series of data, or date ranges, or a list of locations and the like. Next the user the selects populating the report by selecting the base data for the report. In this example the current temperature, current (temperature) set point, and current power usage are selected and read from the controller and are populated in the table 512. However, it should be appreciated that the selected data or parameters could be any data available in or to the building management system 20. As can be seen at 516, the building management system displays the current values associated with the base data set that the user has selected.

Continuing with FIG. 5B, if desired, a user may elect to identify attributes of or modify the data set in some way by adding rules, calculations, or expressions related to the data. For example, an attribute may be information or a characteristic of the data, such as range, accuracy, limits and the like. In another example, in this instance as depicted, the user has established an expression related to the differential between the measured temperature for a space versus the set point as depicted at 518. This information may be insightful to a building manager or operator because they may want to have an understanding of instances that the environmental control system does not provide sufficient heating or cooling to a given building space to ensure that desired set points are tightly adhered to. Note that an expression column 520 is added to the data table 512 on the column tab 510. A user may then elect to display the information regard the differential from the set point established above in a variety of ways. In an embodiment, as depicted in FIG. 5C, the user may elect to add yet another expression 522 as depicted in another column 524 in the data table 512. In this instance, the expression is related to the magnitude of the deviation from the set point and a comparison to a selected threshold. It should also be noted that in this instance, the data is selected to be rendered as a color as depicted by 526 instead of a value. Thereby, based on an arbitrary expression established by the user, a user may preselect any variety of colors and map or remap colors to be displayed.

FIG. 5D depicts a further view of a graphical user interface in a building management system 20 where a user establishes a report to implement the method of dynamic color mapping in accordance with an embodiment. In this instance, once again, a user may then elect to employ another column 528 using a prior column 514 value (for current usage) to create a color gradient. This example maps current energy usage from a range of 0 to 3000 to a color gradient from “black” to “blue” as depicted at 532. In an embodiment, as depicted in FIG. 5D at 530, the user once again selects to have the data rendered as a color instead of a value. The user may then elect functions (a color gradient) and attributes for the color gradient to be displayed.

Finally, FIG. 5E depicts an example view of a partial table of the data, expressions and color selections as selected and configured by the user and applied to each row (and in this example each building in the campus). The building management system 20 is configured to use these selections to provide a mapping of such selections as identified in the table 512. It should be appreciated that the two rightmost columns of the table 512 include selections that were identified as colors, and thus provide the color mapping of the selected data. Once mapped to and displayed with the building or campus layout as depicted in FIG. 4 yielding the depiction in FIG. 5F depicting the mapping for the expression of exceeding the set point tolerance by more than a selected threshold. Likewise, FIG. 5G depicts another color mapping of the same graphic 60 (campus) and graphical objects 62 (buildings 26) using a different data set as the input. In this instance the color mapping is based on energy usage and an expression of energy usage exceeding a selected threshold. It should be appreciated that one of the advantages of the described embodiments is based on the ability to arbitrarily define a variety of data sets and expression to be related to a graphic 60 and the graphical objects 62 thereon and thereby provided a variety of visualizations for the user.

Turning now to FIG. 6 depicting a flowchart of the method 600 of employing arbitrary tabular data as a basis of dynamic color map data visualizations in accordance with an embodiment. The method 600 initiates with process step 610 where a desired graphical depiction 60 is selected. This graphical depiction 60 includes a color mapping of at least one graphical object 62. For example, a mapping of a campus with buildings 26 as depicted in FIG. 4. It should be appreciated that the graphical depiction could be a building layout with rooms or building spaces defined. At process step 620 the method 600 continues with selecting a first data set or parameter associated with the graphical object 62. For example, as described above, the data set or parameter could be a temperature for a building 26 or building space, or temperature set point. In another instances the energy consumed as described above. An attribute associated with the selected parameter may then be developed. For example a set point threshold for the temperature as depicted at process step 630. Turning now to process step 640, in an embodiment, the method 600 continues with a user defining a one or more colors being associated with either the selected parameters and/or the attributes. For example, a color gradient for energy usage as defined above or distinct colors such a red for exceeding at threshold, or green for being within a tolerance of a selected set point for the operation of the system. Finally, at process step 650, the method 600 includes displaying the graphical depiction 60 with the graphical elements having the selected data set and the attribute with the defined color. As depicted in FIGS. 5F and 5G, this may include the same buildings 26 displayed with the new color mapping based on the selected attribute or characteristic.

The present disclosure may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a hard disk, a random access memory (RAM), a read-only memory (ROM), a portable compact disc (CD), a digital versatile disk (DVD), a memory stick, and the like.

Computer readable program instructions described herein can be downloaded to respective computing/processing devices from a computer readable storage medium or to an external computer or external storage device via a network e.g., 18, for example, the Internet, a local area network, a wide area network and/or a wireless network. The network may comprise copper transmission cables, optical transmission fibers, wireless transmission, routers, firewalls, switches, gateway computers and/or edge servers, and the like.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Benefits and advantages of the present disclosure include a method that automatically creates tailored, dynamic, energy efficient, building management system, HVAC and occupancy information and dynamic system color mapping of data based on selected tabular data. Advantageously this approach provides improved visualization for the user and an enhanced user experience. Other advantages include improved system performances and reduction in energy cost as better information about system performance is made available to a user.

The term “about” is intended to include the degree of error associated with measurement of the particular quantity based upon the equipment available at the time of filing the application. For example, “about” can include a range of +8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of using arbitrary tabular data for dynamic color map data visualizations, the method comprising:
identifying a desired graphical depiction having at least one graphical object on the graphical depiction related thereto;
selecting a first data set having values associated with the graphical object;
ascertaining an attribute associated with the data set;
establishing a rule defining a color to be associated with at least one of the first data set and the attribute;
displaying the graphical depiction with the graphical elements having the at least one of the first data set and the attribute with the defined color.

2. The method set forth in claim 1, wherein the selecting includes identifying data associated with the graphical object that a user desires to associate with a visualization.

3. The method set forth in claim 1, wherein the ascertaining includes establishing an expression for the first data set.

4. The method set forth in claim 1, wherein the expression is a mathematical relationship associated with the first data set.

5. The method set forth in claim 1, wherein, the graphical depiction is a map or layout associated with a building management system.

6. The method set forth in claim 5, wherein the map is at least one of a campus having a plurality of buildings and a building having a plurality of building spaces and the graphical elements are the buildings or building spaces.

7. The method set forth in claim 5, wherein the building management system, an environmental control system, an elevator system, and an access control and security system.

8. The method set forth in claim 5, wherein the selected parameter includes at least one of environmental, mechanical, occupancy, and access control or security data.

9. The method set forth in claim 5, wherein the selected parameter includes at least one of temperature, temperature set point, and occupancy.

10. The method set forth in claim 9, wherein the attribute for the selected parameter includes a deviation of the temperature from the temperature set point.

11. The method set forth in claim 1, further including generating a report in a building management system including at least a first result of the selecting, ascertaining, and establishing.

12. The method set forth in claim 11, wherein the report includes a table of the at least a first result.

13. The method set forth in claim 11, further including:
applying a result of the selecting, ascertaining, and establishing to another graphical depiction having another graphical element; and
displaying the another graphical depiction with the another graphical elements employing the defined color.

14. A system for using arbitrary tabular data for dynamic color map data visualizations, the system comprising:
a controller, the controller configured to execute a process comprising:
identifying a desired graphical depiction having a color mapped to at least one graphical object on the graphical depiction;
selecting a first data set associated with the graphical object;
ascertaining an attribute associated with the first data set; and
establishing a rule defining a color to be associated with at least one of the first data set and the attribute; and
a display, the display operably connected to the controller, the display configured to display the graphical depiction with the graphical elements having the at least one of the first data set and the attribute with the defined color.

15. The system set forth in claim 14, wherein the selecting includes identifying data associated with the graphical object that a user desires to associate with a visualization.

16. The system set forth in claim 14, wherein the ascertaining includes establishing an expression for the first data set.

17. The system set forth in claim 14, further including the controller configured to generate a report in a building management system including at least a first result of the selecting, ascertaining, and defining.

18. The system set forth in claim 14, further including:
the controller configured to apply a result of the selecting, ascertaining, and establishing to another graphical depiction having another graphical element; and
the display configured to display the another graphical depiction with the another graphical elements employing the defined color.

19. A building management system for controlling and monitoring systems in a building including an environmental control system, the building management system comprising:
environmental conditioning hardware constructed and arranged to condition the environment; and
a controller including an environment module configured to receive data associated with the environment control system, the controller configured to execute a process comprising:
identifying a desired graphical depiction having a color mapped to at least one graphical object on the graphical depiction;
selecting a first data set associated with the graphical object;
ascertaining an attribute associated with the first data set; and
establishing a rule defining a color to be associated with at least one of the first data set and the attribute; and
a display, the display operably connected to the controller, the display configured to display the graphical depiction with the graphical elements having the at least one of the first data set and the attribute with the defined color.
